(19) United States
(12) Patent Application Publication
(10) Pub. No.: US 2026/0296132 A1
(43) Pub. Date: Oct. 1, 2026

(54) AUTOMOTIVE AIR VENT ACTUATORS

(71) Applicant: Joysonquin Automotive Systems North America, LLC, Troy, MI (US)

(72) Inventors: Melaku Habte, Rochester Hills, MI (US); Liao Yan Wen, High-Tech Ningbo (CN); Hu Wen Long, High-Tech Ningbo (CN); Lu Qi Wen, High-Tech Ningbo (CN)

(21) Appl. No.: 19/447,363

(22) Filed: Jan. 13, 2026

(30) Foreign Application Priority Data
Jan. 13, 2025 (CN) 2025200665140

(51) Int. Cl. B60H 1/00; B60H 1/34

(52) U.S. Cl. CPC B60H 1/00428; B60H 2001/3471

(57) ABSTRACT

In some embodiments, an automotive air vent actuator may include a housing having an upper housing and a lower housing. The housing may define a hollow cavity. The actuator may include a motor vertically arranged within the hollow cavity. The motor may comprise a stator assembly and a rotor assembly separable from the stator assembly. The rotor assembly may include a rotating shaft extending between an upper end and a lower end. The upper housing and the lower housing may each define a mounting groove positioned to correspond to an upper end and a lower end of the rotating shaft. The upper end of the rotating shaft may be configured to be disposed in the mounting groove of the upper housing and the lower end of the rotating shaft may be configured to be disposed in the mounting groove of the lower housing to support the rotating shaft.

### CROSS-REFERENCE TO RELATED APPLICATIONS

This application claims priority to Chinese Patent Application No. CN 202520066514.0 filed on Jan. 13, 2025, the entirety of which is incorporated herein by reference.

### FIELD OF DISCLOSURE

The disclosed systems relate to automotive components. More specifically, the disclosed systems are directed to automotive air vent actuators.

### BACKGROUND

With the development of the automotive industry, especially the rapid advancement of new energy and autonomous driving technologies, automotive electronics have been widely applied and have become an important part of vehicles. The performance of automotive electronics directly affects the power, economy, reliability, safety, and comfort of automobiles. Automotive air vent actuators typically operate such that when a micro motor is powered, the motor rotates at high speed, decelerates through a gear system, and outputs a certain torque and speed through the output gear, which drives the relevant air door through a linkage to achieve the opening, closing, and angle adjustment of the automotive air conditioning air door.

For some conventional automotive air vent actuators, the drive motor of the automotive air conditioning air door actuator is horizontally installed in the housing, and the drive motor is connected to the control circuit on the circuit board through motor wires. For this conventional actuator, first, due to the horizontal installation structure of the drive motor, it is difficult to miniaturize the overall actuator. Second, the circuit board is also horizontally distributed in the housing and needs to cooperate with the positioning and installation of the gears, which increases the overall volume and cost of the circuit board. Moreover, the circuit board and gears can only be assembled step-by-step, making the assembly process cumbersome. Thus, the design of the positioning structure for the horizontally installed circuit boards is challenging.

### SUMMARY

In some embodiments, an automotive air vent actuator may include, a housing having an upper housing and a lower housing. The housing may define a hollow cavity. The automotive air vent actuator may include a motor vertically arranged within the hollow cavity. The motor may include a stator assembly and a rotor assembly separable from the stator assembly. The rotor assembly may include a rotating shaft extending between an upper end and a lower end. The upper housing and the lower housing may each define a mounting groove positioned to correspond to an upper end and a lower end of the rotating shaft. The upper end of the rotating shaft may be configured to be disposed in the mounting groove of the upper housing and the lower end of the rotating shaft may be configured to be disposed in the mounting groove of the lower housing to support the rotating shaft.

In some embodiments, the upper end and the lower end of the rotating shaft may each comprise a spherical structure. The rotating shaft may be configured to engage the mounting grooves via the spherical structures to provide circumferential support for rotation. In some embodiments, the upper end and the lower end of the rotating shaft may each comprise a spherical structure. The mounting grooves of the upper housing and the lower housing may each include a bearing disposed therein. The rotating shaft may be configured to engage the mounting grooves of the upper housing and the lower housing via the spherical structures and the bearings to provide circumferential support for rotation. In some embodiments, the lower end of the rotating shaft may include a spherical structure. The mounting groove of the lower housing may include a bearing disposed therein. The rotating shaft may be configured to engage the mounting groove of the lower housing via the spherical structure and the bearing to provide circumferential support for rotation. In some embodiments, an elastic piece may be attached to an outer wall of the stator assembly. One end of the bearing may be disposed in the mounting groove of the lower housing. Another end of the bearing may be positioned by the elastic piece.

In some embodiments, the automotive air vent actuator may include a transmission assembly including a first gear and a gear shaft. The first gear may be coaxially connected to an upper end of the gear shaft. The automotive air vent actuator may include a positioning plate disposed between the first gear and the motor. The positioning plate may define a shaft mounting groove sized and configured to receive the gear shaft. A lower end of the gear shaft may be disposed in the shaft mounting groove such that the first gear may be rotatably connected to the positioning plate. A lower end of the positioning plate may be connected to an upper end of a side wall of a limiting seat. In some embodiments, the transmission assembly may include a second gear coaxially fixed to the upper end of the rotating shaft. The positioning plate may define a mounting through-hole corresponding to the second gear. The second gear may be disposed within the mounting through-hole and may be configured to mesh with the first gear. In some embodiments, the lower housing may define a limiting seat integrally formed therein. The limiting seat may be configured to secure the stator assembly. In some embodiments, the limiting seat may include a plurality of limiting protrusions integrally formed on an inner peripheral wall thereof. The limiting protrusions may be configured to provide circumferential restriction for the stator assembly. In some embodiments, the motor may include a plurality of motor pins arranged on one side of the stator assembly. The automotive air vent actuator may include a vertically arranged circuit board. The circuit board may have a plurality of pins on one side of the circuit board. The stator assembly may be positioned on an opposite side of the circuit board from the plurality of pins. The plurality of motor pins and the plurality of pins may be inserted into and coupled to the circuit board.

In some embodiments, an automotive air vent actuator may include a housing having an upper housing and a lower housing. The housing may define a hollow cavity. The automotive air vent actuator may include a motor vertically arranged within the hollow cavity. The motor may include a stator assembly and a rotor assembly separable from the stator assembly. The rotor assembly may include a rotating shaft extending between an upper end and a lower end. The upper housing and the lower housing may each define a mounting groove positioned to correspond to the upper end and the lower end of the rotating shaft. The upper end of the rotating shaft may be configured to be disposed in the mounting groove of the upper housing and the lower end of the rotating shaft may be configured to be disposed in the mounting groove of the lower housing to support the rotating shaft. The upper end and the lower end of the rotating shaft may each include a spherical structure.

In some embodiments, the rotating shaft may engage the mounting grooves via the spherical structures to provide circumferential support for rotation. In some embodiments, the lower housing may include a limiting seat integrally formed therein. The limiting seat may be configured to secure the stator assembly. In some embodiments, the limiting seat may include a plurality of limiting protrusions integrally formed on an inner peripheral wall thereof. The limiting protrusions may be configured to provide circumferential restriction for the stator assembly. In some embodiments, the motor may include a plurality of motor pins arranged on one side of the stator assembly. The automotive air vent actuator may include a vertically arranged circuit board. The circuit board may have a plurality of pins on one side of the circuit board. The stator assembly may be positioned on an opposite side of the circuit board from the plurality of pins. The plurality of motor pins and the plurality of pins may be inserted into and coupled to the circuit board.

In some embodiments, an automotive air vent actuator may include a housing having an upper housing and a lower housing. The housing may define a hollow cavity. The automotive air vent actuator may include a motor vertically arranged within the hollow cavity. The motor may include a stator assembly and a rotor assembly separable from the stator assembly. The rotor assembly may include a rotating shaft extending from an upper end to a lower end. The upper housing and the lower housing may each include a mounting groove positioned to correspond to the upper end and the lower end of the rotating shaft. The upper end and the lower end of the rotating shaft may be configured to be disposed in the mounting grooves of the upper housing and the lower housing to support the rotating shaft. The mounting grooves of the upper housing and the lower housing each include a bearing disposed therein.

In some embodiments, the upper end and the lower end of the rotating shaft may each comprise a spherical structure. The rotating shaft may be configured to engage the mounting grooves of the upper housing and the lower housing via the spherical structures and the bearings to provide circumferential support for rotation. In some embodiments, an elastic piece may be attached to an outer wall of the stator assembly. One end of the bearing disposed in the mounting groove of the lower housing may be embedded in the mounting groove of the lower housing, and another end of the bearing disposed in the mounting groove of the lower housing may be positioned by the elastic piece.

In some embodiments, the automotive air vent actuator may include a transmission assembly including a first gear and a gear shaft. The first gear may be coaxially connected to an upper end of the gear shaft. The automotive air vent actuator may include a positioning plate disposed between the first gear and the motor. The positioning plate may define a shaft mounting groove sized and configured to receive the gear shaft. A lower end of the gear shaft may be disposed in the shaft mounting groove such that the first gear may be rotatably connected to the positioning plate. A lower end of the positioning plate may be connected to an upper end of a side wall of a limiting seat. In some embodiments, the transmission assembly may include a second gear coaxially fixed to the upper end of the rotating shaft. The positioning plate may define a mounting through-hole sized and configured to receive the second gear. The second gear may be disposed within the mounting through-hole and may be configured to mesh with the second gear.

In some embodiments, the lower housing may include a limiting seat integrally formed therewith. The limiting seat may be configured to secure the stator assembly. In some embodiments, the limiting seat may include a plurality of limiting protrusions integrally formed on an inner peripheral wall thereof. The limiting protrusions may be configured to provide circumferential restriction for the stator assembly. In some embodiments, the motor may include a plurality of motor pins arranged on one side of the stator assembly. The automotive air vent actuator may include a vertically arranged circuit board. The circuit board may have a plurality of pins on one side of the circuit board. The stator assembly may be positioned on an opposite side of the circuit board from the plurality of pins. The plurality of motor pins and the plurality of pins may be inserted into and coupled to the circuit board.

### BRIEF DESCRIPTION OF THE DRAWINGS

The features and advantages of the present disclosure will be more fully disclosed in, or rendered obvious by, the following detailed descriptions of example embodiments. The detailed descriptions of the example embodiments are to be considered together with the accompanying drawings wherein like numbers refer to like parts and further wherein:

FIG. 1 illustrates an exploded view of one example of an automotive air vent actuator in accordance with some embodiments;

FIG. 2 illustrates a cross-sectional view of a first example of an automotive air vent actuator in accordance with some embodiments;

FIG. 3 illustrates a partial cross-sectional view of one example of an air vent actuator in accordance with some embodiments;

FIG. 4 illustrates a cross-sectional view of a second example of an automotive air vent actuator in accordance with some embodiments; and

FIG. 5 illustrates a cross-sectional view of a third example of an automotive air vent actuator in accordance with some embodiments.

While the present disclosure is susceptible to various modifications and alternative forms, specific embodiments have been shown by way of example in the drawings and will be described in detail herein. It should be understood, however, that the present disclosure is not intended to be limited to the particular forms disclosed. Rather, the present disclosure is to cover all modifications, equivalents, and alternatives falling within the spirit and scope of the disclosure as defined by the appended claims.

### DETAILED DESCRIPTION

This description of the exemplary embodiments is intended to be read in connection with the accompanying drawings, which are to be considered part of the entire written description. It should be understood, however, that the present disclosure is not intended to be limited to the particular forms disclosed and that the drawings are not necessarily shown to scale. Rather, the present disclosure covers all modifications, equivalents, and alternatives that fall within the spirit and scope of these exemplary embodiments. In the description, relative terms such as “length,” “width,” “lower,” “upper,” “front,” “rear,” “left,” “right,” “horizontal,” “vertical,” “above,” “below,” “up,” “down,” “top,” “bottom,” “inner,” “outer,” “clockwise,” “counterclockwise,” “axial,” “planar direction,” and “circumferential” as well as derivatives thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation.

Terms concerning attachments, coupling and the like, such as “connected” and “interconnected” refer to a relationship wherein structures are secured or attached to one another either directly or indirectly through intervening structures, as well as both movable or rigid attachments or relationships, unless expressly described otherwise. The terms “couple,” “coupled,” “operatively coupled,” “operatively connected,” and the like should be broadly understood to refer to connecting devices or components together either mechanically, or otherwise, such that the connection allows the pertinent devices or components to operate with each other as intended by virtue of that relationship.

The present disclosure pertains to automotive air vent actuators. In some embodiments, an automotive air vent actuator may include a housing and a motor. The housing may include an upper housing, a lower housing, and a hollow cavity. The motor may be vertically arranged within the cavity and may include a stator assembly and a rotor assembly separable from the stator assembly. The rotor assembly may include a rotating shaft. The upper housing and the lower housing may be provided with two mounting grooves at positions corresponding to the upper and lower ends of the rotating shaft, and the two ends of the rotating shaft may cooperate with the two mounting grooves to support the rotating shaft. By vertically arranging the motor in the hollow cavity of the housing and utilizing the mounting grooves on the upper and lower housings to support the upper and lower ends of the rotating shaft, the actuator may achieve a more compact overall structure than conventional air vent actuators.

Since the stator assembly and the rotor assembly may be designed to be relatively independent, and the rotating shaft of the rotor assembly may be supported by the mounting grooves, it may be relatively easy to disassemble and assemble the motor components when maintenance or replacement is needed. This not only may reduce maintenance costs but may also improve repair efficiency.

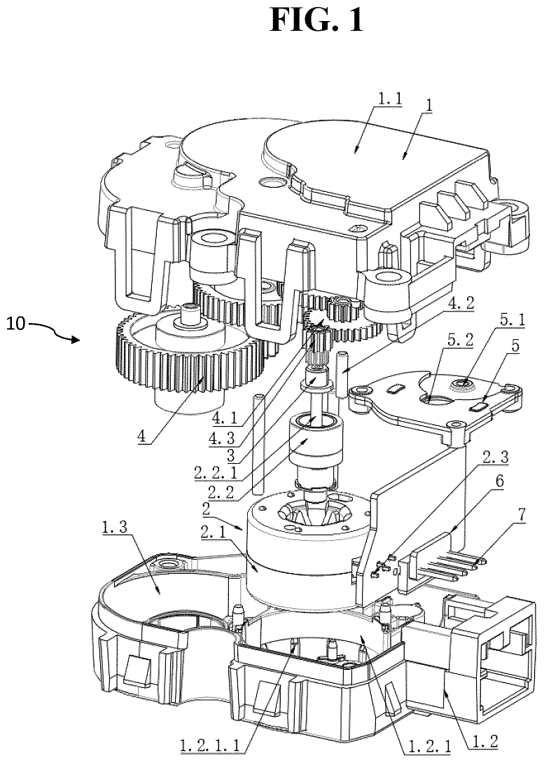

Turning now to the drawings, FIG. 1 illustrates an exploded view of an automotive air vent actuator 10 in accordance with some embodiments. The automotive air vent actuator 10 may include a housing 1 and a motor 2. The housing 1 may include an upper housing 1.1 and a lower housing 1.2. The housing 1 may define a hollow cavity 1.3 between upper housing 1.1 and lower housing 1.2. The motor 2 may be vertically arranged within the cavity 1.3. The motor 2 may include a stator assembly 2.1 and a rotor assembly 2.2 separable from the stator assembly 2.1. The rotor assembly 2.2 may include a rotating shaft 2.2.1.

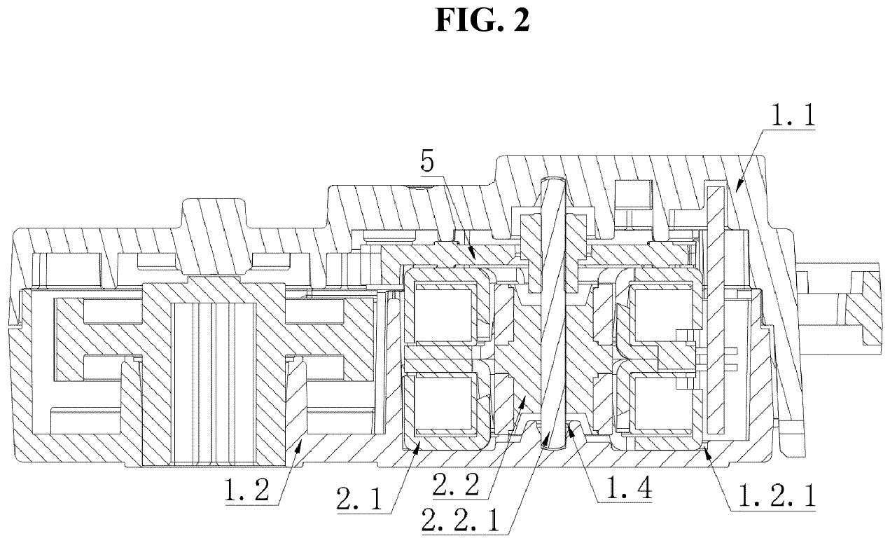

FIG. 2 illustrates a cross-sectional view of a first example of an automotive air vent actuator 10 in accordance with some embodiments. The upper housing 1.1 and the lower housing 1.2 may each define a mounting groove 1.4 at positions corresponding to the upper end and the lower end of the rotating shaft 2.2.1. The two ends of the rotating shaft 2.2.1 may cooperate with the two mounting grooves 1.4 to support the rotating shaft 2.2.1.

In some embodiments, the upper end and the lower end of the rotating shaft 2.2.1 are spherical in structure. The rotating shaft 2.2.1 may cooperate with the two mounting grooves 1.4 through the spherical structures of the upper end and the lower end of the rotating shaft 2.2.1 to provide circumferential support for the rotation of the rotating shaft 2.2.1. The upper end and the lower end rotating shaft 2.2.1 may be firmly installed in the mounting grooves 1.4 of the upper housing and lower housing, which may enhance the stability of the rotating shaft 2.2.1. During operation, the rotating shaft 2.2.1 may maintain smooth rotation, reducing noise and wear caused by vibration or shaking, thereby extending the service life of the actuator 10. The spherical structures of the upper end and lower end of the rotating shaft 2.2.1 may evenly distribute the force generated during the rotation of the rotating shaft 2.2.1, which may provide stable support and help prevent shaking or offset of the rotating shaft 2.2.1 during high-speed rotation, which may ensure stable operation of the actuator 10.

The housing 1 may be provided with a limiting seat 1.2.1 integrally formed in the lower housing 1.2 to install and limit the stator assembly 2.1. The setting of the limiting seat 1.2.1 may facilitate the positioning and installation of the stator assembly 2.1. Referring back to FIG. 1, the limiting seat 1.2.1 may include several limiting protrusions 1.2.1.1 integrally formed on the limiting seat's 1.2.1 inner peripheral wall to provide circumferential limiting for the stator assembly 2.1. In some embodiments, the limiting protrusions 1.2.1.1 may be limiting ribs arranged in the vertical direction. The cooperation of the limiting protrusions 1.2.1.1 and the stator assembly 2.1 may provide for a stable position of the stator assembly 2.1 in the limiting seat 1.2.1, which may avoid loosening or offset caused by vibration or external forces.

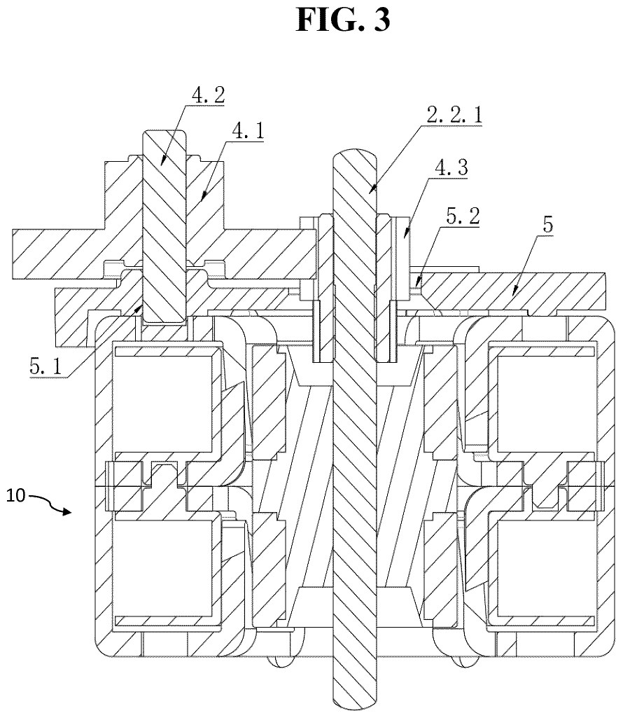

FIG. 3 illustrates a partial cross-sectional view of one example of the air vent actuator 10 in accordance with some embodiments. The actuator 10 may include a transmission assembly 4 (as best seen in FIG. 1). The transmission assembly 4 may include a first gear 4.1 and a gear shaft 4.2. The first gear 4.1 may be coaxially connected to the upper end of the gear shaft 4.2. The actuator 10 may include a positioning plate 5 arranged between the first gear 4.1 and the motor 2. The positioning plate 5 may define a shaft mounting groove 5.1 corresponding to the gear shaft 4.2. The lower end of the gear shaft 4.2 may be embedded in the shaft mounting groove 5.1 so that the first gear 4.1 may be rotatably connected to the positioning plate 5. The lower end of the positioning plate 5 may be connected to the upper end of the side wall of the limiting seat 1.2.1 as best seen in FIG. 1.

The design of the positioning plate 5 may provide a stable support point for the first gear 4.1 and the gear shaft 4.2, which may provide for high stability during installation and use. The coaxial connection of the first gear 4.1 and the gear shaft 4.2, as well as the close cooperation of the gear shaft 4.2 and the shaft mounting groove 5.1, may promote effective power transmission, reduce energy loss during transmission, and improve transmission efficiency. At the same time, the design of the positioning plate may simplify the installation process of the transmission assembly 4, which may reduce installation difficulty and cost.

Referring back to FIG. 1, the transmission assembly 4 may include a second gear 4.3 that may be coaxially pressed onto the upper end of the rotating shaft 2.2.1. The positioning plate 5 may define a mounting through-hole 5.2 corresponding to the second gear 4.3. The second gear 4.3 may be sized and configured to pass through the mounting through-hole 5.2 to mesh with the first gear 4.1. The coaxial connection of the second gear 4.3 and the upper end of the rotating shaft 2.2.1, as well as the coaxial connection of the first gear 4.1 and the gear shaft 4.2, may make the overall structure of the transmission assembly 4 more compact, effectively utilizing the internal space of the actuator 10.

The motor 2 may include several motor pins 2.3 arranged on one side of the stator assembly 2.1. The actuator 10 may include a vertically arranged circuit board 6 and several pins 7 arranged on one side of the circuit board 6. The stator assembly 2.1 may be arranged on the other side of the circuit board 6 opposite the pins 7. The motor pins 2.3 and the pins 7 may be inserted into the circuit board 6 and coupled (e.g., welded soldered, etc.) to it. The connection of the motor pins 2.3 and the circuit board 6, as well as the connection of the pins 7 and the circuit board 6, may simplify the installation process and may provide for stable transmission of electrical signals, avoiding failures caused by poor contact or loosening.

The transmission assembly 4 may include additional gears. For example, the transmission assembly 4 may include a third gear meshing with the first gear 4.1, a fourth gear meshing with the third gear, and a fifth gear meshing with the fourth gear.

During assembly: the second gear 4.3 may be pressed onto the upper end of the rotating shaft 2.2.1, and the lower end of the gear shaft 4.2 of the first gear 4.1 may be pressed into the shaft mounting groove 5.1.

The pins 7 may be inserted into one side of the vertically arranged circuit board 6 and coupled (e.g., welded soldered, etc.) to it. The motor pins 2.3 may be inserted into the other side of the circuit board 6 opposite the pins 7 and coupled (e.g., welded soldered, etc.) to it, such that the circuit board 6 is fixedly connected to the stator assembly 2.1 through the motor pins 2.3.

The stator assembly 2.1 with the circuit board 6 may be vertically installed into the limiting seat 1.2.1. The lower end of the rotating shaft 2.2.1 may cooperate with the mounting groove 1.4 through the spherical structure to provide circumferential support for the rotation of the lower end of the rotating shaft 2.2.1.

The rotor assembly 2.2 may be installed inside the stator assembly 2.1. The gear shafts of the third gear and the fourth gear may be pressed into the lower housing 1.2.

The lower end of the positioning plate 5 with the gear shaft 4.2 of the first gear 4.1 pressed into it may be connected to the upper end of the side wall of the limiting seat 1.2.1. The first gear 4.1 may be placed on the upper end of the positioning plate 5 and coaxially connected to the upper end of the gear shaft 4.2, such that the first gear 4.1 may be rotatably connected to the positioning plate 5.

The second gear 4.3 may be installed through the mounting through-hole 5.2 to mesh with the first gear 4.1. The third gear on the upper end of its gear shaft may be installed to mesh with the first gear 4.1. A fourth gear on the upper end of its gear shaft may be installed to mesh with the third gear. A fifth gear inside the lower housing 1.2 may be installed to mesh with the fourth gear.

The upper housing 1.1 may be installed such that the upper end of the rotating shaft 2.2.1 may cooperate with the mounting groove 1.4 through the spherical structure to provide circumferential support for the rotation of the upper end of the rotating shaft 2.2.1.

The upper housing 1.1 and the lower housing 1.2 may be coupled together, such as through a snap-connect connection.

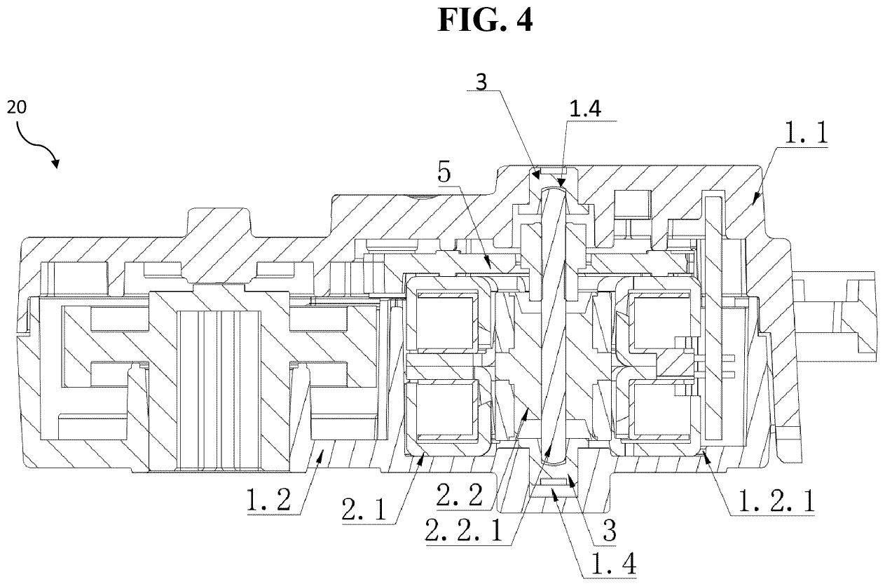

FIG. 4 illustrates a cross-sectional view of a second example of an automotive air vent actuator 20 in accordance with some embodiments. The automotive air vent actuator 20 may include the same or similar features as automotive air vent actuator 10 as discussed above, which is not repeated herein for brevity. In some embodiments, the rotating shaft 2.2.1 may cooperate with the two mounting grooves 1.4 through the spherical structures at both ends. The actuator 20 may include two bearings 3 to provide circumferential support for the rotation of the rotating shaft 2.2.1. The two bearings 3 may significantly reduce friction between the rotating shaft 2.2.1 and the mounting grooves 1.4. The cooperation of the spherical structure of the upper end and the lower end of the rotating shaft 2.2.1 and the bearings 3 may make the rotation of the rotating shaft 2.2.1 smoother, reducing energy loss and wear.

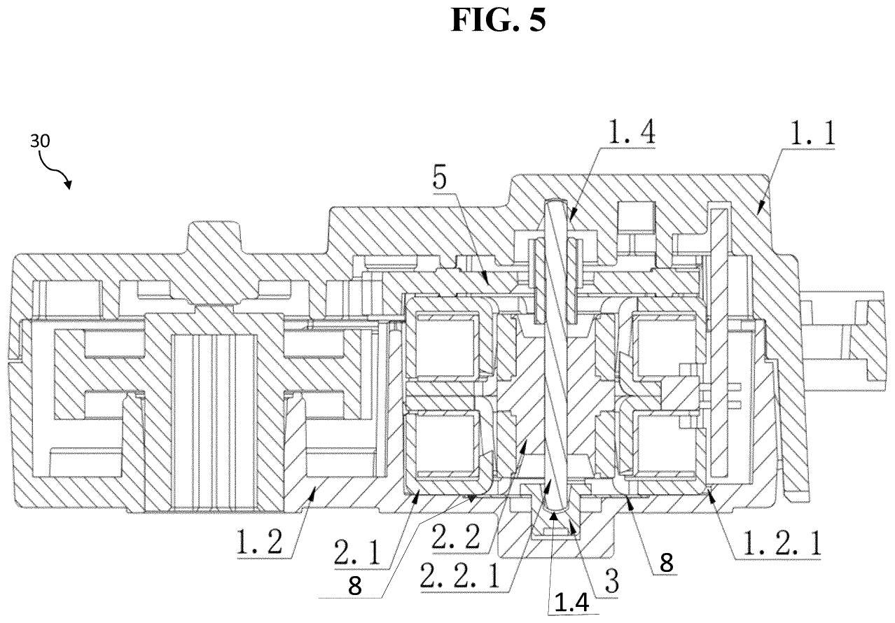

FIG. 5 illustrates a cross-sectional view of a third example of an automotive air vent actuator 30 in accordance with some embodiments. The automotive air vent actuator 30 may include the same or similar features as automotive air vent actuator 10 as discussed above, which is not repeated herein for brevity. The mounting groove 1.4 of the lower housing 1.2 may include a bearing 3 disposed therein. The rotating shaft 2.2.1 may cooperate with the mounting groove 1.4 through the spherical structure at its end and the bearing 3 to provide circumferential support for the rotation of the rotating shaft 2.2.1. The spherical structure of the lower end of the rotating shaft 2.2.1 and the bearing 3 may be able to withstand large radial and axial loads, as well as certain impacts and vibrations, which may ensure stable rotation of the rotating shaft 2.2.1 under complex working conditions, which may improve the reliability and stability of the equipment.

In some embodiments, the bearing 3 may be disposed in the mounting groove 1.4 of the lower housing 1.2, so that the lower end of the rotating shaft 2.2.1 cooperates with the mounting groove 1.4 through the spherical structure and the bearing 3 positioned by an elastic piece 8 to provide circumferential support for the rotation of the lower end of the rotating shaft 2.2.1. The upper end of the rotating shaft 2.2.1 may cooperate with the mounting groove 1.4 through the spherical structure to provide circumferential support for the rotation of the upper end of the rotating shaft 2.2.1. In some embodiments, both the upper housing and lower housing mounting grooves 1.4 include a bearing 3 disposed therein such that the upper end and lower end of the rotating shaft 2.2.1 cooperates with the mounting grooves 1.4 through the spherical structures and the bearings 3 positioned by the elastic piece 8 to provide circumferential support for the rotation of the rotating shaft 2.2.1.

In some embodiments, the outer wall of the stator assembly 2.1 may be attached with an elastic piece 8 as best seen in FIG. 5. One end of the bearing 3 may be embedded in the mounting groove 1.4 of the lower housing 1.2, and the other end of the bearing 3 may be positioned by the elastic piece 8. The elastic piece 8 may position the other end of the bearing 3, which may provide accurate positioning of the bearing 3 in the mounting groove 1.4. The positioning of the bearing 3 in the mounting groove 1.4 may help avoid rotation errors and vibrations caused by inaccurate positioning. The elastic piece 8 may have an elastic buffering effect, which may evenly distribute the stress generated during the rotation of the bearing 3. The even distribution of the stress generated during the rotation of the bearing 3 may help avoid local overload and damage, and may improve the stability and load-bearing capacity of the structure.

The labels in figures are as follows:
1. Housing; 1.1. Upper housing; 1.2. Lower housing; 1.2.1. Limiting seat; 1.2.1.1. Limiting protrusion; 1.3. Cavity; 1.4. Mounting groove; 2. Motor; 2.1. Stator assembly; 2.2. Rotor assembly; 2.2.1. Rotating shaft; 2.3. Motor pin; 3. Bearing; 4. Transmission assembly; 4.1. Second gear; 4.2. Gear shaft; 4.3. Second gear; 5. Positioning plate; 5.1. Shaft mounting groove; 5.2. Mounting through-hole; 6. Circuit board; 7. Pin; 8. Elastic piece.

### FEATURES OF THE DISCLOSURE

In some embodiments, an automotive air vent actuator may include a housing. The housing may include an upper housing, a lower housing, and a hollow cavity. The automotive air vent actuator may include a motor vertically arranged within the cavity. The motor may include a stator assembly and a rotor assembly separable from the stator assembly. The rotor assembly may include a rotating shaft. The upper housing and the lower housing may be provided with two mounting grooves at positions corresponding to the upper and lower ends of the rotating shaft. The two ends of the rotating shaft may cooperate with the two mounting grooves to support the rotating shaft.

In some embodiments, the upper and lower ends of the rotating shaft may both be spherical in structure. The rotating shaft may directly cooperate with the two mounting grooves through the spherical structures to provide circumferential support for the rotation of the rotating shaft.

In some embodiments, the two mounting grooves may be embedded with two bearings, and the rotating shaft may cooperate with the two mounting grooves through the spherical structures at both ends and the two bearings to provide circumferential support for the rotation of the rotating shaft.

In some embodiments, the mounting groove of the lower housing may be embedded with a bearing. The rotating shaft may cooperate with the mounting groove through the spherical structure at its end and the bearing to provide circumferential support for the rotation of the rotating shaft.

In some embodiments, the outer wall of the stator assembly may be attached with an elastic piece. One end of the bearing may be embedded in the mounting groove of the lower housing. The other end of the bearing may be positioned by the elastic piece.

In some embodiments, the housing may be provided with a limiting seat integrally formed in the lower housing to install and limit the stator assembly.

In some embodiments, the limiting seat may be provided with several limiting protrusions integrally formed on its inner peripheral wall to provide circumferential limiting for the stator assembly.

In some embodiments, the actuator may include a transmission assembly. The transmission assembly may include a second gear and a gear shaft. The second gear may be coaxially connected to the upper end of the gear shaft. A positioning plate may be arranged between the second gear and the motor. The positioning plate may be provided with a shaft mounting groove corresponding to the gear shaft. The lower end of the gear shaft may be embedded in the shaft mounting groove so that the second gear may be rotatably connected to the positioning plate. The lower end of the positioning plate may be connected to the upper end of the side wall of the limiting seat.

In some embodiments, the transmission assembly may include a first gear coaxially pressed onto the upper end of the rotating shaft. The positioning plate may be provided with a mounting through-hole corresponding to the first gear. The first gear may pass through the mounting through-hole to mesh with the second gear.

In some embodiments, the motor may include several motor pins arranged on one side of the stator assembly. The actuator may include a vertically arranged circuit board and several pins arranged on one side of the circuit board. The stator assembly may be arranged on the other side of the circuit board. The motor pins and the pins may be inserted into the circuit board and welded to it.

It may be emphasized that the above-described embodiments, particularly any “preferred” embodiments, are merely possible examples of implementations, set forth for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure.

While this specification contains many specifics, these should not be construed as limitations on the scope of any disclosures, but rather as descriptions of features that may be specific to a particular embodiment. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments.

Although the disclosure has been described in terms of exemplary embodiments, it is not limited thereto. Rather, the appended claims should be construed broadly, to include other variants and embodiments of the disclosure, which may be made by those skilled in the art without departing from the scope and range of equivalents of the disclosure.

1-23. (canceled)

24. An automotive air vent actuator, comprising:
a housing including an upper housing, a lower housing, and a hollow cavity; and
a motor vertically arranged within the cavity, the motor comprising a stator assembly and a rotor assembly separable from the stator assembly, the rotor assembly including a rotating shaft;
wherein the upper housing and the lower housing each include a mounting groove positioned to correspond to upper and lower ends of the rotating shaft; and
wherein the upper and lower ends of the rotating shaft are configured to engage the mounting grooves to support the rotating shaft.

25. The actuator of claim 24, wherein the upper and lower ends of the rotating shaft each comprise a spherical structure, and the rotating shaft is configured to directly engage the mounting grooves via the spherical structures to provide circumferential support for rotation.

26. The actuator of claim 24, wherein the mounting grooves each include a bearing, and the rotating shaft is configured to engage the mounting grooves via the spherical structures and the bearings to provide circumferential support for rotation.

27. The actuator of claim 24, wherein the mounting groove of the lower housing includes a bearing, and the rotating shaft is configured to engage the mounting groove via the spherical structure at its lower end and the bearing to provide circumferential support for rotation.

28. The actuator of claim 27, wherein an elastic piece is attached to an outer wall of the stator assembly, one end of the bearing is embedded in the mounting groove of the lower housing, and another end of the bearing is positioned by the elastic piece.

29. The actuator of claim 27, wherein the limiting seat includes a plurality of limiting protrusions integrally formed on an inner peripheral wall thereof, the protrusions being configured to provide circumferential restriction for the stator assembly.

30. The actuator of claim 27, further comprising:
a transmission assembly including a second gear and a gear shaft, wherein the second gear is coaxially connected to an upper end of the gear shaft; and
a positioning plate disposed between the second gear and the motor, the positioning plate including a shaft mounting groove corresponding to the gear shaft, wherein a lower end of the gear shaft is embedded in the shaft mounting groove such that the second gear is rotatably connected to the positioning plate;
wherein a lower end of the positioning plate is connected to an upper end of a side wall of the limiting seat.

31. The actuator of claim 24, wherein the lower housing includes a limiting seat integrally formed therewith, the limiting seat being configured to install and secure the stator assembly.

32. The actuator of claim 31, wherein the transmission assembly further includes a first gear coaxially fixed to an upper end of the rotating shaft, and the positioning plate includes a mounting through-hole corresponding to the first gear, the first gear passing through the mounting through-hole and being configured to mesh with the second gear.

33. The actuator of claim 24, wherein the motor further includes a plurality of motor pins arranged on one side of the stator assembly;
wherein the actuator further includes a vertically arranged circuit board and a plurality of pins on one side of the circuit board;
wherein the stator assembly is positioned on an opposite side of the circuit board;
and wherein the motor pins and the pins are inserted into and soldered to the circuit board.
